(19) United States
(12) Patent Application Publication
(10) Pub. No.: US 2026/0058794 A1
(43) Pub. Date: Feb. 26, 2026

(54) LATENCY-CONTROLLED INTEGRITY AND DATA ENCRYPTION (IDE)

(71) Applicant: Rambus Inc., San Jose, CA (US)

(72) Inventor: Yu Cheng Liao, Zhubei city (TW)

(21) Appl. No.: 18/994,817

(22) PCT Filed: Sep. 20, 2023
(86) PCT No.: PCT/US2023/033290

§ 371 Date: Jan. 15, 2025

Related U.S. Application Data
(60) Provisional application No. 63/409,161, filed on Sep. 22, 2022.
(60) Provisional application No. 63/425,260, filed on Nov. 14, 2022.

(51) Int. Cl. H04L 9/06

(52) U.S. Cl. CPC H04L 9/0631

(57) ABSTRACT

Technologies for providing integrity and data encryption (IDE) with zero latency are described. One receiving device with a cryptographic circuit having an Advanced Encryption Standard (AES) engine with a fixed epoch size and a fixed latency for IDE can send a delay parameter to a transmitting device. The delay parameter represents a number of clock cycles corresponding to the fixed latency. The cryptographic circuit can pre-determine, using the AES engine, AES data for a first epoch before first input data of the first epoch is received from the transmitting device. After the number of clock cycles, the cryptographic circuit can receive the first input data from the transmitting device. The cryptographic circuit can determine first output data for the first epoch using the AES data and the first input data without storing the AES data in a buffer.

### BACKGROUND

Modern computer systems generally include one or more memory devices, such as those on a memory module. The memory module may include, for example, one or more random access memory (RAM) devices or dynamic random access memory (DRAM) devices. A memory device can include memory banks made up of memory cells that a memory controller or memory client accesses through a command interface and a data interface within the memory device. The memory module can include one or more volatile memory devices. The memory module can be a persistent memory module with one or more non-volatile memory (NVM) devices.

### BRIEF DESCRIPTION OF THE DRAWINGS

The present disclosure is illustrated by way of example, and not by way of limitation, in the figures of the accompanying drawings.

FIG. 1 is a block diagram of a transmitting device and a receiving device with latency-controlled cryptographic circuits for integrity and data encryption (IDE) according to at least one embodiment.

FIG. 2 is a block diagram of an in-line memory encryption (IME) block for latency-controlled IDE according to at least one embodiment.

FIG. 3 is a sequence diagram of a transmitting device and a receiving device for latency-controlled IDE according to at least one embodiment.

FIG. 4 is a block diagram of a latency-controlled cryptographic circuit with an Advanced Encryption Standard (AES) engine with multiple levels of a pipeline and an XOR operation according to at least one embodiment.

FIG. 5 illustrates how to achieve zero latency in seven clock cycles of a pipeline of an AES engine according to at least one embodiment.

FIG. 6 illustrates how to stall the pipeline of FIG. 5 when no data is transferred according to at least one embodiment.

FIG. 7 is a block diagram of a memory system with a memory module with an IME block with latency control according to at least one embodiment.

FIG. 8 is a block diagram of an integrated circuit with a memory controller, an encryption circuit with latency control, and a management processor according to at least one embodiment.

FIG. 9 illustrates a method 900 in accordance with one embodiment.

### DETAILED DESCRIPTION

The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

Datacenter architectures are evolving to support the workloads of emerging applications in Artificial Intelligence and Machine Learning that require a high-speed, low latency, cache-coherent interconnect. Compute Express Link® (CXL®) is an industry-supported cache-coherent interconnect for processors, memory expansion, and accelerators. The CXL® technology defines mechanisms called Integrity and Data Encryption (IDE) for providing confidentiality, integrity, and replay protection for data transferred over a CXL® link. The CXL® IDE mechanism can secure traffic within a Trusted Execution Environment (TEE) of multiple components. One IDE algorithm is Advanced Encryption Standard (AES) Galois/Counter Mode (GCM) (hereinafter the AES-GCM algorithm. The AES-GCM algorithm uses AES-256 for the encryption and a hash function called GHASH to produce a message authentication code (MAC) for an authentication tag. AES-GCM also supports Additional Authenticated Data (AAD) which is authenticated using GHASH but transmitted as plaintext. The GHASH algorithm belongs to a class of Wegman-Carter polynomial universal hashes. Other encryption and authentication algorithms can be used.

The CXL® protocol is highly sensitive to latency, and the IDE algorithm, AES-GCM, can have a latency penalty when an EPOCH (also referred to herein as epoch) is started. An AES engine can take 7 or 14 cycles from the input of the EPOCH computing the AES data for the output. For example, a basic AES operation can include expanding a key, performing an initial process on input data, and then round calculations repeated 7 or 14 times to provide an output, resulting in the 7 or 14 cycles for the basic AES operation. For example, one integrated circuit operating at 1 GHz can require one cycle for each round calculation, resulting in 14 cycles for the 128-bit output. Another integrated circuit can do two round calculations in one clock cycle, resulting in 7 cycles for the 128-bit output. As such, there is a latency penalty of 7 or 14 clock cycles.

Aspects of the present disclosure and embodiments address these problems and others by providing a latency-controlled cryptographic circuit that can have zero latency or low latency for IDE by calculating AES data in advance before it is needed and performing an XOR operation on the main data path with the input data as it arrives. The latency-controlled cryptographic circuit can control when the input data (e.g., plaintext or ciphertext) arrives to correspond to when the AES data is ready for the XOR operation in the main data path. The latency-controlled cryptographic circuit can prepare the AES engine to be ready to receive a corresponding flit with no latency. A flit (also referred to as a flow control unit or digit) is a link-level atomic piece of data that forms a network packet or stream. An AES engine can have a pre-determined input and calculate an AES output. The AES output can be pre-determined by the AES engine and available for the XOR operation when the input data (e.g., plaintext or ciphertext) arrives in the main data path.

Aspects of the present disclosure and embodiments can be used for all applications with a fixed epoch size (also referred to as a fixed epoch length) when using the AES-GCM algorithm. For example, in the CXL® IDE specification, the input of the AES engine (e.g., AES encoder or AES decoder) is pre-defined with a fixed epoch size of 5 or 128 flits, and the AES engine has a fixed latency, such as 7 or 14 clock cycles. A programmable pre-operation delay of the AES engine can be used to pre-calculate the required AES data before the normal operation for transmitting or receiving data. The AES output can be ready before needed or as needed. Aspects of the present disclosure and embodiments can be used for all applications with a variable range of epoch size but fixed to a known epoch size. With the pre-known epoch size, the inputs of an AES engine can be pre-determined and ready at the right time. Even if the epoch size is truncated, as allowed by the CXL® IDE specification, the latency-controlled cryptographic circuit can handle the epoch correctly by purging an AES pipeline with a defined delay.

It should be noted that some solutions have considered pre-calculating AES output to reduce latency, but these solutions require an additional buffer or static random access memory (SRAM) to store the AES data until it is needed. The major problems are the buffer usually has an access latency, such as 2 or 3, and the area and power consumption of the buffer are large. Aspects of the present disclosure and embodiments can pre-calculate all required AES output at an accurate time, so there is no need for an additional buffer or SRAM to store AES output in advance. Removing the additional buffer or SRAM to store AES output can significantly reduce latency, implementation area, and power.

Aspects of the present disclosure and embodiments can use an AES stall mechanisms to control an AES pipeline to stall an input and output at a same time if no data transfer is stopped or stalled. Aspects of the present disclosure and embodiments can calculate a MAC in parallel as data arrives. As described herein, the MAC can be used to verify the correctness of the encrypted data. The MAC (authentication tag) can be calculated as part of a MAC calculation path.

In at least one embodiment, the latency-controlled cryptographic circuit can be part of a device that supports the CXL® technology, such as a CXL® memory module. The CXL® memory module can include a CXL® controller or a CXL® memory expansion device (e.g., CXL® memory expander System on Chip (SoC)) that is coupled to DRAM (e.g., one or more volatile memory devices) and/or persistent storage memory (e.g., one or more NVM devices). The CXL® memory expansion device can include a management processor. The CXL® memory expansion device can include an error correction code (ECC) circuit to detect and correct errors in data read from memory or transferred between entities. The CXL® memory expansion device can use the CXL® memory module, such as an IME circuit, to encrypt the host's unencrypted data before storing it in the DRAM. The IME circuit can generate a MAC, as described herein, that can be used to verify the encrypted data.

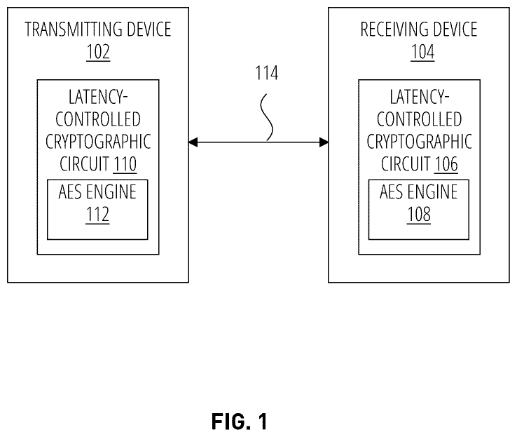

FIG. 1 is a block diagram of a transmitting device 102 and a receiving device 104 with latency-controlled cryptographic circuits 110 and 106, respectively, for integrity and data encryption (IDE) according to at least one embodiment. The receiving device 104 includes a latency-controlled cryptographic circuit 106 with an AES engine 108. The AES engine 108 has a fixed epoch size and a fixed latency for receive (RX) IDE. The latency-controlled cryptographic circuit 106 can send a delay parameter to the transmitting device 102. The receiving device 104 and the transmitting device 102 can be connected over a link 114. Link 114 can be any type of connection between two devices. The delay parameter can represent a number of clock cycles corresponding to the fixed latency of the AES engine 108. The latency-controlled cryptographic circuit 106 can pre-determine, using the AES engine 108, AES data for a first epoch before first input data of the first epoch is received from the transmitting device 102. After the number of clock cycles, the latency-controlled cryptographic circuit 106 can receive the first input data from the transmitting device 102. The latency-controlled cryptographic circuit 106 can determine first output data for the first epoch using the AES data and the first input data without storing the AES data in a buffer. That is, the receiving device 104 does not have an additional buffer or SRAM dedicated to storing the AES data. The AES data is ready when the first input data arrives from the transmitting device 102. The latency-controlled cryptographic circuit 106 can perform an XOR operation with the first input data and the AES data to obtain the first output data as the first input data arrives at the latency-controlled cryptographic circuit 106. In at least one embodiment, the first input data is ciphertext, and the first output data is plaintext. For example, the transmitting device 102 can send encrypted data, including the ciphertext, over link 114 to the receiving device 104, and the receiving device 104 can decrypt the encrypted data, including the plaintext. In at least one embodiment, the first input data is ciphertext, and the first output data is plaintext. The latency-controlled cryptographic circuit 106 can perform these operations in the receiving device 104 to achieve zero or low latency for RX IDE.

Similar operations can be performed on the transmitting device 102 to achieve zero or low latency for transmit (TX) IDE. In at least one embodiment, the transmitting device 102 includes the latency-controlled cryptographic circuit 110 with AES engine 112. The AES engine 112 has a fixed epoch size and a fixed latency for TX IDE. The latency-controlled cryptographic circuit 110 can pre-determine, using the AES engine 112, AES data for a first epoch before first input data of the first epoch is input into the AES engine 112. The latency-controlled cryptographic circuit 110 can determine, after a first number of clock cycles corresponding to the latency of the AES engine 112, first output data for the first epoch using the AES data and the first input data without storing the AES data in a buffer. That is, the transmitting device 102 does not have an additional buffer or SRAM dedicated to storing the AES data. The AES data is ready when the first input data is input into the AES engine 112. The latency-controlled cryptographic circuit 110 can perform an XOR operation with the first input data and the AES data to obtain the first output data as the first input data arrives at the AES engine 112. The transmitting device 102 can send the first output data to the receiving device 104. In at least one embodiment, the first input data is plaintext, and the first output data is ciphertext. For example, the transmitting device 102 can send encrypted data, including the ciphertext, over link 114 to the receiving device 104, and the receiving device 104 can decrypt the encrypted data, including the plaintext. In at least one embodiment, the first input data is ciphertext, and the first output data is plaintext. In some cases, the latency-controlled cryptographic circuit 110 can send a delay parameter to the receiving device 104 to indicate the first number of clock cycles. The latency-controlled cryptographic circuit 106 can perform these operations in the receiving device 104 to achieve zero or low latency for RX IDE.

In at least one embodiment, the latency-controlled cryptographic circuit 106 can pre-determine AES input data for the first epoch before the AES data for the first epoch is pre-determined. For example, the latency-controlled cryptographic circuit 106 can pre-determine the AES input data from a counter output. A counter can receive an initialization vector (IV) to produce a counter output. The counter can be incremented for each round calculation. The output of the counter can be used to pre-determine the AES data before the data for the first epoch arrives at the latency-controlled cryptographic circuit 106. In at least one embodiment, the latency-controlled cryptographic circuit 110 can pre-determine AES input data for the first epoch before the AES data for the first epoch is pre-determined. For example, the latency-controlled cryptographic circuit 110 can pre-determine the AES input data from a counter output.

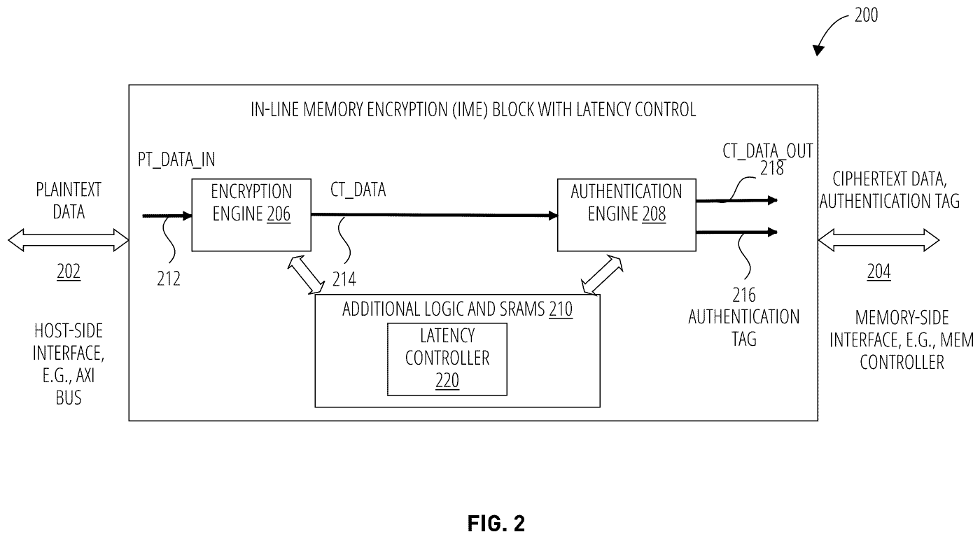

In at least one embodiment, the latency-controlled cryptographic circuit 106 can determine, using the AES engine 108, an authentication tag associated with the first epoch in parallel with determining the first output data. The authentication tag is used to verify the correctness of the first output data. In at least one embodiment, the latency-controlled cryptographic circuit 110 can determine, using the AES engine 112, an authentication tag associated with the first epoch in parallel with determining the first output data. Additional details of the latency-controlled cryptographic circuit 106 and latency-controlled cryptographic circuit 110 are described below with respect to FIG. 2 to FIG. 6.

FIG. 2 is a block diagram of an in-line memory encryption (IME) block 200 for latency-controlled IDE according to at least one embodiment. The IME block 200 provides encryption, decryption, and authentication for memory read and write requests between a host processor via a host-side interface and its attached memory via a memory-side interface. The IME block 200 can be instantiated on a host system (e.g., System on Chip (SoC) or Field Programmable Gate Array (FPGA)) between the processor logic and a memory controller. The IME block 200 can be a high-throughput, low-latency security solution. The IME block 200 can be implemented in hardware, software, firmware, or any combination thereof. The IME block 200 can receive plaintext data 202 over the host-side interface, encrypt the plaintext data 202 into ciphertext data, generate an authentication tag 216, and provide an output 204 to memory over the memory-side interface. Output 204 includes the final ciphertext data 218 and the authentication tag 216. The IME block 200 can receive ciphertext data and authentication tag from the memory controller over the memory-side interface, decrypt the data and provide the decrypted data over the host-side interface. The IME block 200 can implement encryption and authentication algorithms, such as the AES-GCM algorithm. The AES-GCM algorithm uses AES-256 for encryption and GMAC for authentication. The GMAC internally uses the GHASH functions to generate authentication tag 216. In at least one embodiment, the IME block 200 can generate a Message Authentication code (MAC) tag for each segment (or portion or multiple segments or portions) received from a source node over the host-side interface. As illustrated in FIG. 2, the generation of the MAC tag is performed in connection with an authentication algorithm that uses a hashing function to compute the MAC tag. In other embodiments, the generation of the MAC tag is performed in connection with another operation, such as an encryption operation. In at least one embodiment, the authentication algorithm is the GMAC algorithm, and the hash function is the GHASH function. Alternatively, other authentication algorithms and/or hash functions can be used.

In at least one embodiment, the IME block 200 includes an encryption engine 206, an authentication engine 208, and additional logic and SRAMs 210, including a latency controller 220. The additional logic and SRAMs 210 can be used to perform other operations and store information in connection with the encryption and authentication operations. For simplicity, the IME block 200 shows a process flow of encryption with an encryption engine 206. The encryption engine 206 (also referred to herein as encryption logic) can receive the plaintext data 202 as segments (or portions) and encrypt the segments into segments 214 (or portions) of ciphertext data. The segments or portions can be epochs or flits of an epoch. The authentication engine 208 can use GMAC for authentication, including the GHASH function, to generate authentication tag 216. Before outputting the final authentication tag 216, the authentication engine 208 can output an intermediate state that is stored by the additional logic and SRAMs 210 in the event of an error. The intermediate state can include an intermediate hash state of a hash computation and an intermediate initialization vector (IV). The intermediate state can also store a counter output.

In at least one embodiment, the encryption engine 206 (encryption logic) receives segments 212 of plaintext data 202 of a data burst and outputs segments 214 of cyphertext data of the data burst. The authentication engine 208 (authentication logic) receives segments 214 of the cyphertext data, outputs a final authentication tag 216 associated with the data burst, and the final ciphertext data 218.

In at least one embodiment, the latency controller 220 can control the encryption engine 206 to pre-determine AES data before the arrival of segments 212 so that the AES data is ready when segments 212 arrive and no additional buffer or SRAM is used to store the AES data, as described herein. The latency controller 220 can determine or store a fixed latency of the encryption engine 206 to pre-determine the AES data. The latency controller 220 can send a delay parameter to a source node sending the plaintext data 202. The delay parameter can represent a number of clock cycles corresponding to the fixed latency of the encryption engine 206. The latency controller 220 can cause the encryption engine 206 to pre-determine the AES data within the number of clock cycles so that the AES data is ready when the corresponding plaintext data 202 arrives at the encryption engine 206. The latency controller 220 can also control the encryption engine 206 when data is not transferred or stalled, as described in more detail below.

In at least one embodiment, the IME block 200 includes data-integrity (DI) detection logic to detect an error. The error can result from a DI error in one or more of an encryption computation by the encryption engine 206, an authentication computation by the authentication engine 208, an SRAM operation by the additional logic and SRAMs 210, or an I/O operation. The DI detection logic can be part of, or coupled to, the encryption engine 206. The DI detection logic can be part of, or coupled to, the authentication engine 208. The DI detection logic can be part of, or coupled to the additional logic and SRAMs 210. In other embodiments, each stage of the IME block 200 can include DI detection logic to detect errors in the authentication operations, the encryption operations, SRAM operations, I/O operations, or the like.

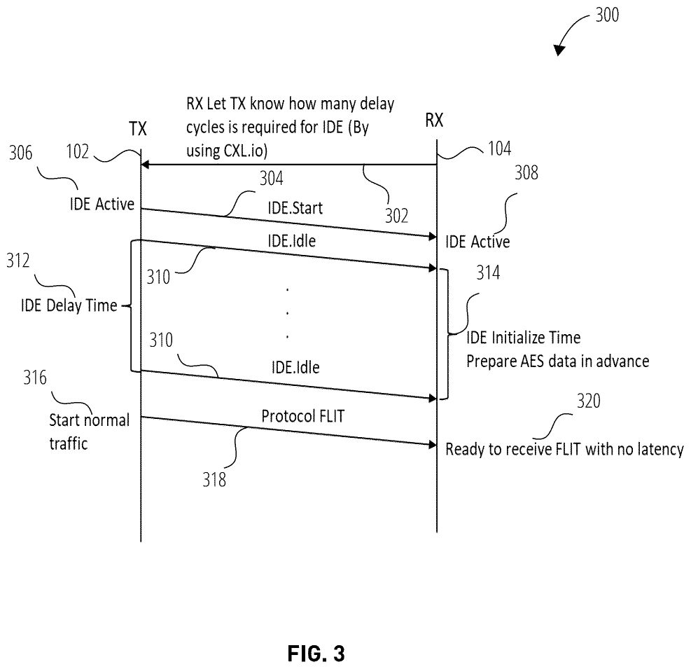

FIG. 3 is a sequence diagram 300 of a transmitting device 102 and a receiving device 104 for latency-controlled IDE according to at least one embodiment. The receiving device 104 can send a delay parameter in a first command 302 to the transmitting device 102. The delay parameter represents a number of clock cycles corresponding to a fixed latency of an AES engine of the receiving device 104 (e.g., AES engine 108). In at least one embodiment, the receiving device 104 can send the first command 302, including the delay parameter, over a management interface. The management interface can use the CXL.io protocol. The delay parameter can let the transmitting device 102 know how many delay cycles are required for an IDE mode. The transmitting device 102 can then activate 306 the IDE mode. In response, the transmitting device 102 can program an IDE delay time 312 with the number of clock cycles in the delay parameter received from the receiving device 104 and send a second command 304 to the receiving device 104 that causes the receiving device 104 to initialize 308 for the AES mode. In at least one embodiment, the transmitting device 102 can send the second command 304 to the receiving device 104 over the management interface. The transmitting device 102 can start the IDE delay time 312 and send a third command 310 to the receiving device 104 that causes the receiving device to start an IDE initialization time 314. The receiving device 104 can use the IDE initialization time 314 to prepare AES data in advance. The transmitting device 102 can send the third command 310 periodically or at the end of the IDE delay time 312. In at least one embodiment, the transmitting device 102 can send the second command 304 to the receiving device 104 over the management interface. After the IDE delay time 312, the transmitting device 102 can start normal traffic 316 and send a protocol flit 318 to the receiving device 104. Since the IDE initialization time 314 equals the IDE delay time 312, the receiving device 104 is ready to receive the flit data with no latency. For example, during the IDE initialization time 314, the receiving device 104 can pre-determine, using the AES engine 108, the AES data for the first epoch. After the number of clock cycles of the IDE initialization time 314, the receiving device 104 receives a first flit of the first epoch from the transmitting device 102 over a data interface. The receiving device 104 is ready to receive the first flit with no latency after the number of clock cycles.

In at least one embodiment, the receiving device 104 can determine, using the AES engine 108, an authentication tag associated with the first epoch in parallel with determining the first output data. The authentication tag can be a partial or final authentication tag. In at least one embodiment, the authentication tag is a MAC.

In another embodiment, the transmitting device 102 can send the second command 304 and the third command(s) 310 before sending the protocol flit 318. In some cases, the transmitting device 102 can send the first command with a delay parameter of the AES engine 112.

In another embodiment, the transmitting device 102 can receive a delay parameter in a first command from the receiving device over a management interface. The delay parameter represents a second number of clock cycles corresponding to a fixed latency of an AES engine of the receiving device 104. The transmitting device 102 can send a second command to the receiving device 104 over the management interface, the second command to cause the receiving device 104 to initialize the AES engine 108 of the receiving device 104. The transmitting device 102 can send a third command to the receiving device 104 over the management interface, the third command to cause the receiving device 104 to pre-determine, using the AES engine 108 of the receiving device 104, the AES data for the first epoch. After the second number of clock cycles, the transmitting device 102 can send a first flit of the first epoch to the receiving device 104 over a data interface. The AES engine 108 of the receiving device 104 is ready to receive the first flit with no latency after the second number of clock cycles. In a further embodiment, the second number of clock cycles and the first number of clock cycles at least partially overlap in time.

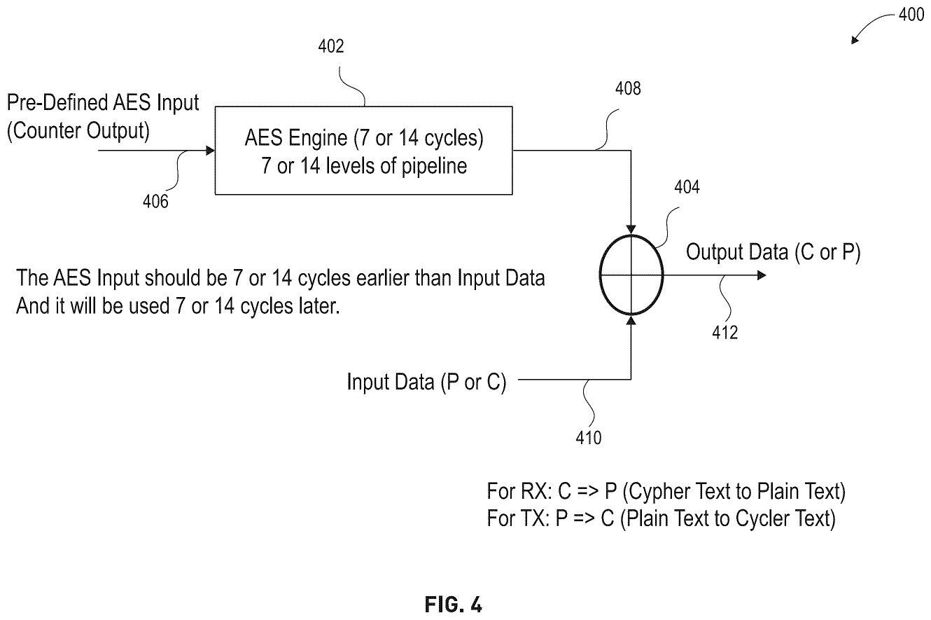

FIG. 4 is a block diagram of a latency-controlled cryptographic circuit 400 with an AES engine 402 with multiple levels of a pipeline and an XOR operation 404 according to at least one embodiment. The latency-controlled cryptographic circuit 400 can be the latency-controlled cryptographic circuit 106 of FIG. 1, latency-controlled cryptographic circuit 110 of FIG. 1, the encryption engine 206 of FIG. 1, the transmitting device 102 of FIG. 1 or FIG. 3, the receiving device 104 of FIG. 1 or FIG. 3, or the like. The AES engine 402 receives pre-defined AES input 406. The pre-defined AES input 406 can be the counter output. The AES engine 402 includes a pipeline of multiple levels, such as 7 or 14. In at least one embodiment, the number of pipeline levels equals the number of clock cycles. In some cases, the number of flits in the fixed epoch size is less than or greater than the number of clock cycles. The AES engine 402 can output pre-defined AES output 408. The pre-defined AES input 406 should be input into the AES engine 402 a number of clock cycles, such as 7 or 14, before input data 410 arrives. The pre-defined AES output 408 determined by the AES engine 402 is used the number of clock cycles later in the XOR operation 404 to determine output data 412. The XOR operation 404 can be a bitwise XOR operation. The input data 410 can be plaintext (P) or ciphertext (C), and output data 412 can be ciphertext (C) or plaintext (P). The latency-controlled cryptographic circuit 400 can be used in a receiving or transmitting device. For the receiving device, the input data 410 is ciphertext (C) and the output data 412 is plaintext (P). For the transmitting device, the input data 410 is plaintext (P), and the output data 412 is ciphertext (C).

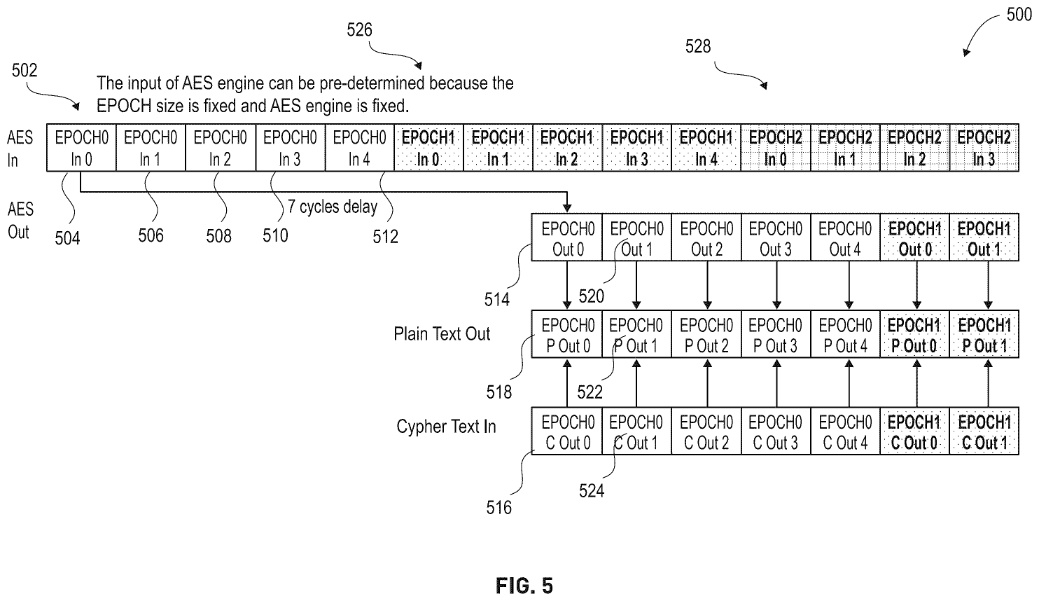

FIG. 5 illustrates how to achieve zero latency in seven clock cycles of a pipeline 500 of an AES engine according to at least one embodiment. In this embodiment, pipeline 500 has a fixed latency of seven clock cycles. The AES engine is configured for an epoch size of 5 flits. Because the epoch size is fixed at five and the AES engine's latency is fixed, the input of the AES engine can be pre-determined. This allows pipeline 500 to pre-determine an AES output with seven delay cycles.

As illustrated, pipeline 500 pre-determines a first AES input data 504 for a first epoch 502 at a first level of pipeline 500. For example, pipeline 500 can receive the AES input data 504 from a counter output. Pipeline 500 processes the first AES input data 504 over subsequent levels of pipeline 500. After the seven clock cycles, pipeline 500 produces first AES data 514 for the first epoch 502. At that time (i.e., after the seven cycles of delay), pipeline 500 receives first flit 516 for the first epoch 502, and pipeline 500 determines first AES output data 518 for the first epoch 502. In this embodiment, the number of flits is five, and the number of levels is 7. So, pipeline 500 can receive five flits of the first epoch and two flits of a second epoch before determining a first output flit for the first epoch.

At the next clock cycle after receiving the 504, pipeline 500 receives second AES input data 506 at the first level of pipeline 500. Pipeline 500 processes the second AES input data 506 over the subsequent levels of pipeline 500. After the seven clock cycles, pipeline 500 produces second AES data 520 for the first epoch 502. At that time (i.e., after seven cycles of delay), pipeline 500 receives a second flit 524 for the first epoch 502, and pipeline 500 determines second AES output data 522 for the first epoch 502. As illustrated, the AES data (e.g., 514, 520) for the first epoch 502 are pre-determined at a same time the corresponding flits (e.g., 516, 524) arrive to produce the AES output data (e.g., 518, 522). This repeats for the third AES input data 508, fourth AES input data 510, and fifth AES input data 512.

After pre-determining the AES input data (e.g., 504 to 512), pipeline 500 pre-determines AES input data for a second epoch 526. After seven cycles of delay, pipeline 500 receives flits for the second epoch 526 to produce AES output data from the flits and AES input data. Similarly, after pre-determining the AES input data for the second epoch 526, pipeline 500 starts to pre-determine AES input data for a third epoch 528.

In at least one embodiment, all the flits (also referred to as FLITs) in the Media Access Control (MAC) epoch can be processed together. That means one key and one Initialization Vector (IV) are used for all the flits in the epoch. The key switch can happen at the boundaries of the MAC epoch. So, all the flits of a first epoch would use one key and one IV. The flits of a second epoch would use a different key and IV. The MAC for the flits of the first epoch can be processed with the IV and the key from the previous epoch.

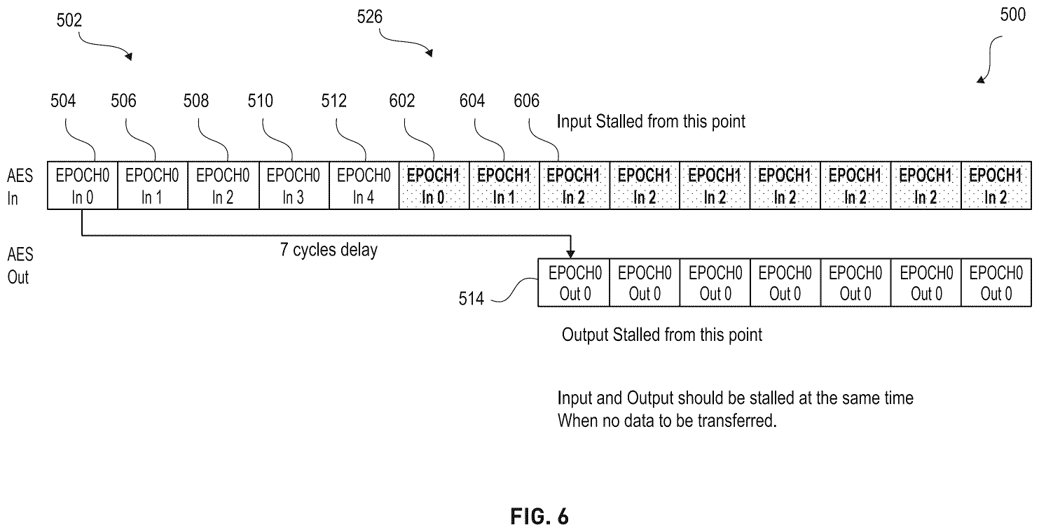

As illustrated in FIG. 5, pipeline 500 can achieve zero latency because the AES data is pre-determined within the fixed latency of the seven cycles. In other embodiments, the pipeline can have different numbers of levels, fixed latencies, and epoch sizes. In some cases, no data is transferred, and the AES engine's input and output should be stalled, as illustrated in FIG. 6.

FIG. 6 illustrates how to stall pipeline 500 of FIG. 5 when no data is transferred according to at least one embodiment. As illustrated in FIG. 6, pipeline 500 pre-determines the first AES input data 504 for the first epoch 502 at the first level of pipeline 500. For example, pipeline 500 can receive the AES input data 504 from a counter output. Pipeline 500 processes the first AES input data 504 over subsequent levels of pipeline 500. After the seven clock cycles, pipeline 500 produces first AES data 514 for the first epoch 502. At that time (i.e., after the seven cycles of delay), it is determined that no data is transferred. When no data is transferred, the input and output of pipeline 500 are stalled at the same time. That is, a current input flit is stalled from this point, and a current output flit is stalled from this point. The pre-calculated data (not finalized yet) can stay inside the pipeline 500 of the AES engine until it can be used. For example, pipeline 500 has the AES input data for the first epoch 502, first AES input data 602, second AES input data 604, and third AES input data 606. Since no data is transferred after the delay, the third AES input data 606 is stalled at the input, and the first AES data 514 is stalled at the output. The epochs after the stall are not needed to calculate fully during the stall period, so the partially-calculated data can stay in the AES pipeline as it is not needed at the current time. When data resumes, the pipeline can resume accordingly. No additional computing power is used, and no additional SRAM is needed to store AES output. This can save power consumption and area. The fixed epoch size allows the AES input to change in advance. In cases where the epoch is terminated before it ends, the estimating of the AES input can break. However, a delay can be inserted after early MAC termination, so this period can be used to pre-determine the required AES data for the next epoch.

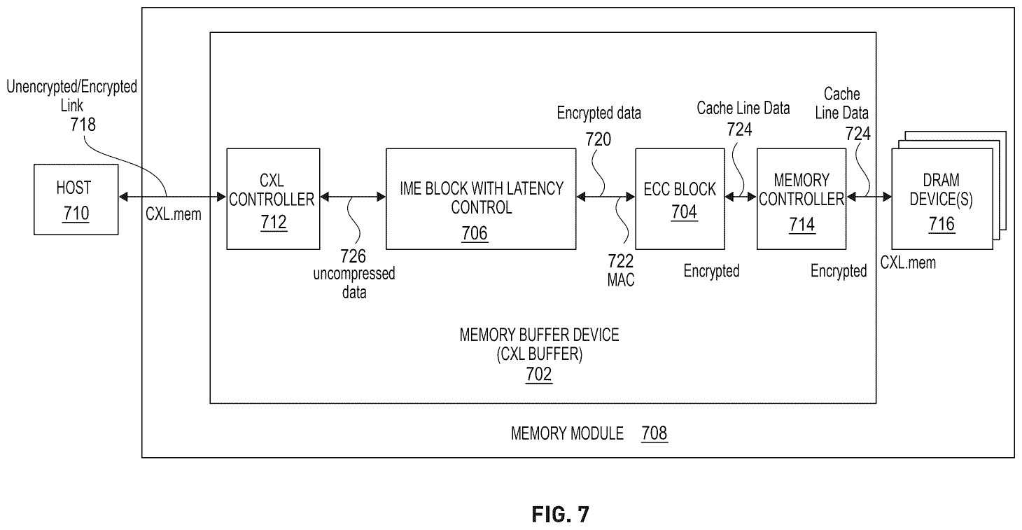

FIG. 7 is a block diagram of a memory system 700 with a memory module 708 with an IME block with latency control 706 according to at least one embodiment. In one embodiment, the memory module 708 includes a memory buffer device 702 and one or more DRAM device(s) 716. In one embodiment, the memory buffer device 702 is coupled to one or more DRAM device(s)s 716 and a host 710. In another embodiment, the memory buffer device 702 is coupled to a fabric manager that is operatively coupled to one or more hosts. In another embodiment, the memory buffer device 702 is coupled to host 710 and the fabric manager. A fabric manager is software executed by a device, such as a network device or switch, that manages connections between multiple entities in a network fabric. The network fabric is a network topology in which components pass data to each other through interconnecting switches. A network fabric includes hubs, switches, adapter endpoints, etc., between devices.

In one embodiment, the memory buffer device 702 includes the IME block with latency control 706. The IME block with latency control 706 is similar to the IME block 200 of FIG. 2. In at least one embodiment, the IME block with latency control 706 can send or receive decrypted data 726 (or encrypted data with a MAC) from host 710. In another embodiment, the IME block with latency control 706 can receive encrypted data 720 from the DRAM device(s) 716. In some instances, decrypted or encrypted data is stored in the DRAM device(s) 716 and retrieved by the memory buffer device 702 to be encrypted into encrypted (or re-encrypted data) by the IME block with latency control 706 before being stored back in the DRAM device(s) 716 or transferred to the host 710.

In at least one embodiment, the IME block with latency control 706 can generate a MAC 722 for each cache line to provide cryptographic integrity on accesses to the respective cache line or a set of cache lines of the encrypted data 720.

In at least one embodiment, the IME block with latency control 706 can verify one or more MACs associated with the encrypted data stored in DRAM device(s) 716. The one or more MACs were previously generated. The IME block with latency control 706 can decrypt the encrypted data to obtain decrypted data.

In one embodiment, the memory buffer device 702 includes an ECC block 704 (e.g., ECC circuit) to detect and correct errors in cache lines or sets of cache lines being read from a DRAM device(s) 716. In at least one embodiment, ECC block 704 can generate and verify ECC information stored with each cache line or set of cache lines. The ECC block 704 can detect and correct an error in a cache line of the data using the ECC information.

The memory buffer device may include a CXL® controller coupled to the compression block, one or more hosts, and a memory controller coupled to the ECC block and the DRAM device.

In a further embodiment, the memory buffer device 702 includes a CXL® controller 712 and a memory controller 714. The CXL® controller 712 is coupled to host 710 and the IME block with latency control 706. The memory controller 714 is coupled to one or more DRAM devices 716. In a further embodiment, the memory buffer device 702 includes a management processor and a root of trust (not illustrated in FIG. 7). In at least one embodiment, the management processor can receive one or more management commands through a command interface between the host 710 (or fabric manager) and the management processor. In at least one embodiment, the memory buffer device 702 is implemented in a memory expansion device, such as a CXL® memory expander SoC of a CXL® NVM module or a CXL® module. The memory buffer device 702 can encrypt unencrypted data (e.g., plain text or cleartext user data), received from a host 710, using the IME block with latency control 706 to obtain encrypted data 720 before storing the encrypted data 720 in DRAM device(s) 716.

In some cases, the IME block with latency control 706 can receive encrypted data for transmission across the link. The IME block with latency control 706 can generate a MAC 722 associated with the encrypted data 720. In at least one embodiment, the IME block with latency control 706 is an IME engine. In another embodiment, the IME block with latency control 706 is an encryption circuit or logic. The ECC block 704 can receive the encrypted data 720 from the IME block with latency control 706. The ECC block 704 can generate ECC information associated with the encrypted data 720. The encrypted data 720, the MAC 722, and the ECC information can be organized as cache line data 724. The memory controller 714 can receive the cache line data 724 from the ECC block 704 and store the cache line data 724 in the DRAM device(s) 716.

It should be noted that the memory buffer device 702 can receive unencrypted and encrypted data as it traverses a link (e.g., the CXL® link). This encryption is usually link encryption, referred to in CXL® as integrity and data encryption. The link encryption, in this case, would not persist to DRAM as the CXL® controller 712 in the memory module 708 can decrypt the link data and verify its integrity before the flow described herein where the IME block with latency control 706 encrypts the data and generates the MAC 722. Although “unencrypted data” is used herein, in other embodiments, the data can be encrypted data that is encrypted by the memory buffer device 702 using a key only used for the link, and thus cleartext data exists within the SoC after the CXL® controller 712 and thus needs to be encrypted by the IME block with latency control 706 to provide encryption for data at rest. In other embodiments, the IME block with latency control 706 does not encrypt the data but still generates the MAC 722.

In at least one embodiment, the CXL® controller 712 includes a host memory interface (e.g., CXL.mem) and a management interface (e.g., CLX.io). The host memory interface can receive, from the host 710, one or more memory access commands of a remote memory protocol, such as the CXL® protocol, Gen-Z, Open Memory Interface (OMI), Open Coherent Accelerator Processor Interface (OpenCAPI), or the like. The management interface can receive one or more management commands of the remote memory protocol from the host 710 or the fabric manager by way of the management processor.

In at least one embodiment, the IME block with latency control 706 receives a data stream from a host 710 and encrypts the data stream into the encrypted data 720, and provides the encrypted data 720 to the ECC block 704 and the memory controller 714. Memory controller 714 stores the encrypted data in the DRAM device(s) 716 along with the MAC 722 and the ECC information as the cache line data 724. This cache line data 724 can be accessed as individual cache lines. At some point, the memory buffer device 702 can determine that the encrypted data stored in DRAM device(s) 716 should be compressed. This can be done to save space in DRAM device(s) 716, for example. The memory buffer device 702 can retrieve the encrypted data. The IME block with latency control 706 can verify the one or more MACs associated with the encrypted data being retrieved. The IME block with latency control 706 can decrypt the encrypted data to obtain uncompressed data. The IME block with latency control 706 can encrypt the decrypted data 726 to obtain the encrypted data 720. The IME block with latency control 706 can generate the MAC 722 for the compressed data. The ECC block 704 can generate ECC information. The encrypted data 720, the MAC 722, and the ECC information can be organized as cache line data 724. The memory controller 714 can receive the cache line data 724 from the ECC block 704 and store the cache line data 724 in the DRAM device(s) 716. This cache line data 724 can be accessed as a set of multiple cache lines.

In some embodiments, the memory module 708 has persistent memory backup capabilities where the management processor can access the encrypted data 720 and transfer the encrypted data from the DRAM device(s) 716 to persistent memory (not illustrated in FIG. 7) in the event of a power-down event or a power-loss event. The encrypted data 720 in the persistent memory is considered data at rest. In at least one embodiment, the management processor transfers the encrypted data to the persistent memory using an NVM controller (e.g., NAND controller).

The IME block with latency control 706 can include multiple encryption functions, such as a first encryption function that uses 128-bit AES encryption and a second encryption function that uses 256-bit AES encryption. In other embodiments, the encryption functions can also provide cryptographic integrity, such as using a MAC. In other embodiments, cryptographic integrity can be provided separately from encryption. In some cases, the strength of the MAC and encryption algorithms can differ. The first encryption function can have a first encryption strength, such as AES-256 encryption. In at least one embodiment, the IME block with latency control 706 is an IME engine with two encryption functions. In another embodiment, the IME block with latency control 706 includes two separate IME engines, each having one of the two encryption functions. In another embodiment, the IME block with latency control 706 includes a first encryption circuit for the first encryption function and a second encryption circuit for the second encryption function. Alternatively, additional encryption functions can be implemented in the IME block with latency control 706. The memory controller 714 can receive the encrypted data 720 from the IME block with latency control 706 and store the encrypted data 720 in the DRAM device(s) 716 from the IME block with latency control 706.

In at least one embodiment, the MAC can be calculated on a first encrypted data stored with a second encrypted data as part of the algorithm (e.g., AES) or separately with a different algorithm. The memory controller 714 can receive the encrypted data 720 and MAC 722 from the IME block with latency control 706 and store the encrypted data 720 and MAC 722 in the DRAM device(s) 716. The host-to-unencrypted memory path can bypass the IME block with latency control 706 for all host transactions. The host-to-unencrypted memory path can still pass through the IME block with latency control 706 for generating the MAC 722.

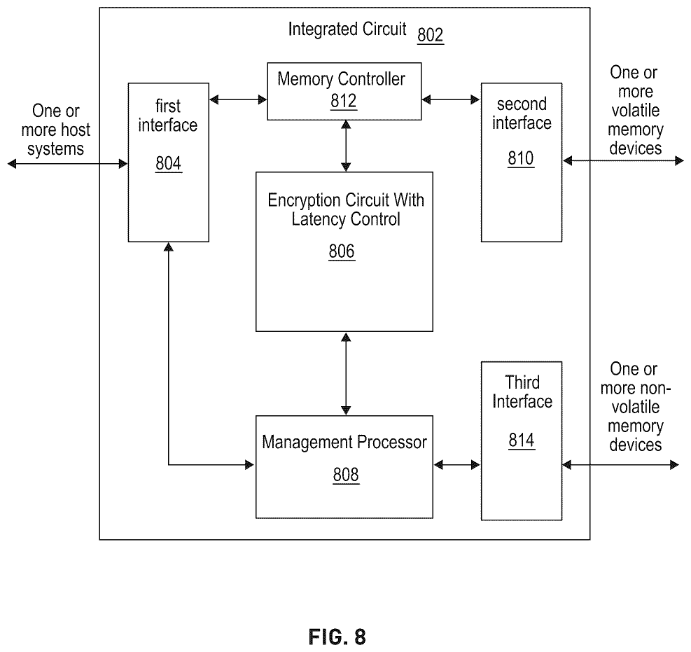

FIG. 8 is a block diagram of an integrated circuit 802 with a memory controller 812, an encryption circuit with latency control 806, and a management processor 808 according to at least one embodiment. In at least one embodiment, the integrated circuit 802 is a controller device that can communicate with one or more host systems (not illustrated in FIG. 8) using a cache-coherent interconnect protocol (e.g., the Compute Express Link (CXL®) protocol). The integrated circuit 802 can be a device that implements the CXL® standard. The CXL® protocol can be built upon physical and electrical interfaces of a PCI Express® standard with protocols that establish coherency, simplify the software stack, and maintain compatibility with existing standards. The integrated circuit 802 includes a first interface 804 coupled to the one or more host systems or a fabric manager, a second interface 810 coupled to one or more volatile memory devices (not illustrated in FIG. 8), and may include a third interface 814 coupled to one or more non-volatile memory devices (not illustrated in FIG. 8). The one or more volatile memory devices can be DRAM devices. The integrated circuit 802 can be part of a single-host memory expansion integrated circuit, a multi-host memory pooling integrated circuit coupled to multiple host systems over multiple cache-coherent interconnects, or the like.

In one embodiment, the memory controller 812 receives data from a host over the first interface 804 or from a volatile memory device over the second interface 810. Memory controller 812 can send the data or a copy of the data to the encryption circuit with latency control 806. The encryption circuit with latency control 806 can be similar to the latency-controlled cryptographic circuit 106 or latency-controlled cryptographic circuit 110 of FIG. 1. The encryption circuit with latency control 806 can operate similarly to the IME block 200 of FIG. 2, the latency-controlled cryptographic circuit 400 of FIG. 4, pipeline 500 of FIG. 5, IME block with latency control 706 of FIG. 7, or the like. The fixed latency of the encryption circuit with latency control 806 can be stored in register data. The encryption circuit with latency control 806 can include an encryption circuit, encryption logic, decryption circuit, decryption logic, an IME block, an IME engine, IME logic, or an encryption block to encrypt data. The encryption circuit with latency control 806 can include MAC circuitry to generate, verify and store MACs, as described herein. In at least one embodiment, the encryption circuit with latency control 806 includes an ECC block or circuit that can generate ECC information, as described herein.

In another embodiment, the one or more non-volatile memory devices are coupled to a second memory controller of the integrated circuit 802. In another embodiment, the integrated circuit 802 is a processor that implements the CXL® standard and includes the encryption circuit with latency control 806 and memory controller 812. In another embodiment, the integrated circuit 802 can include more or fewer interfaces than three.

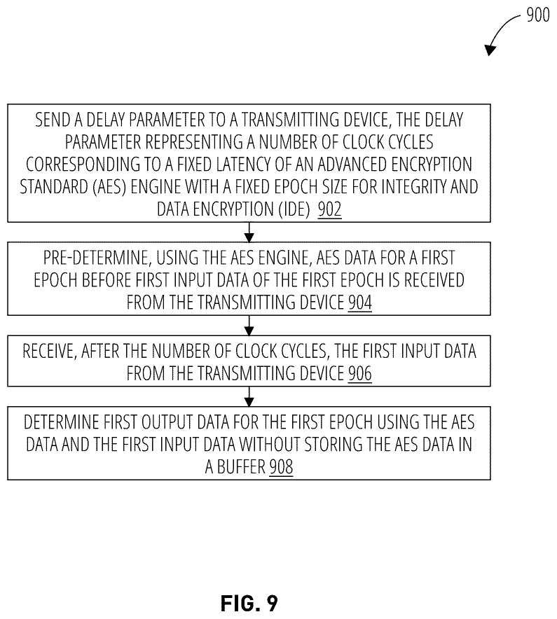

FIG. 9 is a flow diagram of a method 900 for latency-controlled IDE according to at least one embodiment. The method 900 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 900 is performed by the latency-controlled cryptographic circuit 106 or latency-controlled cryptographic circuit 110 of FIG. 1. In at least one embodiment, IME block 200 of FIG. 2 performs the method 900. In another embodiment, the latency-controlled cryptographic circuit 400 of FIG. 4 performs the method 900. In another embodiment, pipeline 500 of FIG. 5 performs the method 900. In another embodiment, the IME block with latency control 706 of FIG. 7 performs the method. In another embodiment, the memory buffer device 702 of FIG. 7 performs the method 900. In another embodiment, the method 900 is performed by a memory expansion device. In another embodiment, the method 900 is performed by the memory module 708 of FIG. 7. In another embodiment, the method 900 is performed by an integrated circuit 802 of FIG. 8, having the encryption circuit with latency control 806. Alternatively, other devices can perform the method 900.

Referring to FIG. 9, the method 900 begins with the processing logic sending a delay parameter to a transmitting device (block 902). The delay parameter can represent a number of clock cycles corresponding to a fixed latency of an AES engine with a fixed epoch size for IDE. At block 904, the processing logic pre-determines, using the AES engine, AES data for a first epoch before first input data of the first epoch is received from the transmitting device. At block 906, the processing logic receives the first input data from the transmitting device after the number of clock cycles. At block 908, the processing logic determines first output data for the first epoch using the AES data and the first input data without storing the AES data in a buffer.

In a further embodiment, the processing logic determines, using the AES engine, an authentication tag associated with the first epoch in parallel with determining the first output data. The processing logic can pre-determine AES input data from a counter output before pre-determining the AES data.

In a further embodiment, the processing logic sends the delay parameter in a first command to the transmitting device over a management interface. The processing logic can receive a second command from the transmitting device over the management interface. The processing logic initializes the AES engine in response to the second command. The processing logic can receive a third command from the transmitting device over the management interface. The AES data can be pre-determined in response to the third command. After the number of clock cycles, the processing logic receives a first flit of the first epoch from the transmitting device over a data interface. The processing logic is ready to receive the first flit with no latency after the number of clock cycles.

It is to be understood that the above description is intended to be illustrative and not restrictive. Many other implementations will be apparent to those of skill in the art upon reading and understanding the above description. Therefore, the disclosure scope should be determined with reference to the appended claims, along with the full scope of equivalents to which such claims are entitled.

In the above description, numerous details are set forth. It will be apparent, however, to one skilled in the art that the aspects of the present disclosure may be practiced without these specific details. In some instances, well-known structures and devices are shown in block diagram form rather than in detail to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

However, it should be borne in mind that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “setting,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk, including floppy disks, optical disks, CD-ROMs, magnetic-optical disks, read-only memories (ROMs), random access memories (RAMs), erasable programmable ROMs (EPROMs), electrically erasable programmable ROMs (EEPROMs), magnetic or optical cards, or any type of media suitable for storing electronic instructions, each coupled to a computer system bus.

The algorithms and displays presented herein are not inherently related to any particular computer or other apparatus. Various general-purpose systems may be used with programs in accordance with the teachings herein, or it may prove convenient to construct more specialized apparatuses to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any procedure for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

What is claimed is:

1. A receiving device comprising:
a cryptographic circuit comprising an Advanced Encryption Standard (AES) engine with a fixed epoch size and a fixed latency for integrity and data encryption (IDE), wherein the cryptographic circuit is to:
send a delay parameter to a transmitting device, the delay parameter representing a number of clock cycles corresponding to the fixed latency;
pre-determine, using the AES engine, AES data for a first epoch before first input data of the first epoch is received from the transmitting device;
receive, after the number of clock cycles, the first input data from the transmitting device; and
determine first output data for the first epoch using the AES data and the first input data without storing the AES data in a buffer.

2. The receiving device of claim 1, wherein the cryptographic circuit is further to pre-determine AES input data for the first epoch before the AES data for the first epoch is pre-determined.

3. The receiving device of claim 2, wherein the cryptographic circuit is to pre-determine the AES input data from a counter output.

4. The receiving device of claim 1, wherein the first input data is plaintext, and the first output data is ciphertext.

5. The receiving device of claim 1, wherein the first input data is ciphertext, and the first output data is plaintext.

6. The receiving device of claim 1, wherein the AES engine comprises a number of levels of a pipeline, wherein the number of levels corresponds to the number of clock cycles.

7. The receiving device of claim 6, wherein a number of flits of the first epoch is five, and the number of levels is 7, wherein the AES engine is to receive five flits of the first epoch and two flits of a second epoch before determining a first output flit for the first epoch.

8. The receiving device of claim 6, wherein, in response to no data being transferred between the transmitting device and the receiving device, inputs and outputs of the pipeline are stalled at a same time.

9. The receiving device of claim 1, wherein the cryptographic circuit is to determine, using the AES engine, an authentication tag associated with the first epoch in parallel with determining the first output data.

10. The receiving device of claim 1, wherein the cryptographic circuit is to:
send the delay parameter in a first command to the transmitting device over a management interface;
receive a second command from the transmitting device over the management interface, the second command to cause the cryptographic circuit to initialize the AES engine;
receive a third command from the transmitting device over the management interface, the third command to cause the cryptographic circuit to pre-determine, using the AES engine, the AES data for the first epoch; and
after the number of clock cycles, receive a first flit of the first epoch from the transmitting device over a data interface, wherein the cryptographic circuit is ready to receive the first flit with no latency after the number of clock cycles.

11. The receiving device of claim 1, further comprising:
a CXL controller coupled to one or more hosts and the cryptographic circuit; and
a memory controller coupled to a dynamic random access memory (DRAM) device, wherein the cryptographic circuit comprises an in-line memory encryption (IME) block with the AES engine and an error correction code (ECC) block.

12. A transmitting device comprising:
a cryptographic circuit comprising an Advanced Encryption Standard (AES) engine with a fixed epoch size and a fixed latency for integrity and data encryption (IDE), the fixed latency corresponding to a first number of clock cycles, wherein the cryptographic circuit is to:
pre-determine, using the AES engine, AES data for a first epoch before first input data of the first epoch is input into the AES engine;
determine, after the first number of clock cycles, first output data for the first epoch using the AES data and the first input data without storing the AES data in a buffer; and
send the first output data to a receiving device.

13. The transmitting device of claim 12, wherein the first input data is plaintext, and the first output data is ciphertext.

14. The transmitting device of claim 12, wherein the AES engine comprises a number of levels of a pipeline, wherein the number of levels corresponds to the first number of clock cycles.

15. The transmitting device of claim 12, wherein the cryptographic circuit is to determine, using the AES engine, an authentication tag associated with the first epoch in parallel with determining the first output data.

16. The transmitting device of claim 12, wherein the cryptographic circuit is to:
receive a delay parameter in a first command from the receiving device over a management interface, the delay parameter representing a second number of clock cycles corresponding to a fixed latency of an AES engine of the receiving device;
send a second command to the receiving device over the management interface, the second command to cause the receiving device to initialize the AES engine of the receiving device;
send a third command to the receiving device over the management interface, the third command to cause the receiving device to pre-determine, using the AES engine of the receiving device, the AES data for the first epoch; and
after the second number of clock cycles, send a first flit of the first epoch to the receiving device over a data interface, wherein the AES engine of the receiving device is ready to receive the first flit with no latency after the second number of clock cycles.

17. The transmitting device of claim 16, wherein the second number of clock cycles and the first number of clock cycles at least partially overlap in time.

18. A method of operating a receiving device, the method comprising:
sending a delay parameter to a transmitting device, the delay parameter representing a number of clock cycles corresponding to a fixed latency of an Advanced Encryption Standard (AES) engine with a fixed epoch size for integrity and data encryption (IDE);
pre-determining, using the AES engine, AES data for a first epoch before first input data of the first epoch is received from the transmitting device;
receiving, after the number of clock cycles, the first input data from the transmitting device; and
determining first output data for the first epoch using the AES data and the first input data without storing the AES data in a buffer.

19. The method of claim 18, further comprising determining, using the AES engine, an authentication tag associated with the first epoch in parallel with determining the first output data.

20. The method of claim 18, further comprising:
sending the delay parameter in a first command to the transmitting device over a management interface;
receiving a second command from the transmitting device over the management interface;
initializing the AES engine in response to the second command;
receiving a third command from the transmitting device over the management interface, wherein the pre-determining of the AES data is performed in response to the third command; and
after the number of clock cycles, receiving a first flit of the first epoch from the transmitting device over a data interface, wherein the receiving device is ready to receive the first flit with no latency after the number of clock cycles.
